(19) United States
(12) Patent Application Publication
(10) Pub. No.: US 2002/0071930 A1
(43) Pub. Date: Jun. 13, 2002

(54) Modular floor covering edge treatment

(76) Inventors: David D. Oakey, LaGrange, GA (US); Jeffery Joseph Roman, Peachtree City, GA (US); John Bradford, LaGrange, GA (US); Keith N. Gray, Kennesaw, GA (US); David H. Gustashaw, Pine Mountain, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/882,849

(22) Filed: Jun. 15, 2001

Related U.S. Application Data
(63) Continuation-in-part of application No. PCT/US00/01717, filed on Jan. 25, 2000.
(60) Provisional application No. 60/130,795, filed on Apr. 23, 1999.
(60) Provisional application No. 60/148,043, filed on Aug. 4, 1999.

(51) Int. Cl. B32B 3/02

(52) U.S. Cl. 428/85

(57) ABSTRACT

Textile fiber face modular flooring having edges treated to mimic the appearance of grout between installed modules or otherwise provide visual demarcation between modules and methods and apparatus for producing such modules.

### RELATED APPLICATION

This application is a continuation-in-part of PCT Patent Application No. PCT/US00/01717 filed Jan. 25, 2000 entitled “Modular Floor Covering Edge Treatment,” which is incorporated by reference herein.

### FIELD OF THE INVENTION

This invention relates to floor coverings, including carpet and carpet tile and resilient sheet and tile products such as vinyl flooring, and a machine and method of making these floor coverings.

### BACKGROUND OF THE INVENTION

Modules of stone, brick, concrete, tile and other refractory products have long been used for flooring. Many such products are installed with a cementitious material like mortar, called “grout” between modules, and such grouted regions are quite prominent and substantially contribute to the appearance of the finished floor. Some resilient flooring such as vinyl flooring has long mimicked the appearance of tile modules with grout between the tiles, even in roll goods of substantial width having very few actual seams. However, textile face floor covering like carpet and carpet tile has generally sought to hide the seams between adjacent modules or other floor covering components, striving for “invisible” seams.

Floor covering, including carpet, is produced in modular or tile forms as well as in broadloom or roll goods. Substantial effort has been devoted to making seams between abutting roll goods and tile edges invisible or at least difficult to see, so that a visually continuous expanse of floor covering is seen. Upstanding yarn pile products facilitate hiding seams because of the tendency of the pile on opposite sides of a seam to intermingle.

Additionally, carpet seams or the edges of carpet tiles are susceptible to fraying or raveling. Such fraying or raveling creates an unpleasant appearance and reduces the life of the carpet. Fraying or raveling problems are increased with flooring consisting of a thin or low face weight, textile fiber based face. Flooring with a flat woven face fabric makes it particularly difficult to hide seams because there is no upstanding pile that can intermingle.

Such thin flooring provides many advantages such as resiliency to deformation caused by heavy loads, reduction in the amount of materials required to produce the carpet, increased durability, and design flexibility available from woven face fabrics. One drawback of these carpets is that due to the thin nature of the top layer and the resulting flat appearance it is difficult to provide a three dimensional appearance with some portions of the floor covering surface higher than others.

### SUMMARY OF THE INVENTION

This invention addresses the issues associated with seams or abutting regions of adjacent floor covering pieces or modules by doing exactly the opposite of one of the objects of great effort in the arts of manufacture and installation of textile face floor coverings. Rather than seeking to make seams invisible, the location of such seams is emphasized, so that the appearance created is of modular units with clear demarcation between adjacent units, somewhat similar to the appearance of traditional ceramic tile with grouted regions between adjacent tiles.

Such border regions between carpet or other textile floor covering tiles or modules are created by treating a peripheral region around the entire module so that it is visually different from the remainder of the tile or module. Each module for a floor area is treated similarly so that when the edges of all the modules are placed together a consistent edge region is created at the edges of each module. The region formed by adjacent treated portions of modules greatly decreases the noticability of the “seam” or demarcation between modules. This “grouted edge treatment” can be accomplished in a number of different ways, including “manual” and automated ones.

Among other alternatives for accomplishing this flooring modular edge treatment are one or a combination of (1) use of a colorant such as a dye, ink or pigment, (2) treatment of the edge with energy to elevate the temperature enough to cause at least a change in appearance, (3) impregnating or otherwise treating the region with a plastic material such as a thermoplastic like a hot melt adhesive, and (4) cutting away a portion of the face material of the modular flooring. Treatment with energy and use of a hot melt adhesive can bond face fabric fibers, thereby consolidating the fiber. Hot melt adhesive on adjacent tile or module edges can be reheated after tile installation to bond adjacent tiles edge-to-edge and create a water-impervious floor covering as well as a grout-like appearance.

Such edge treatment could also potentially be accomplished by transferring color onto a carpet or other flooring surface, such as by using a sublimatic transfer printer in which a vacuum is created so that dye stuffs sublimate from paper onto carpet.

Module edges can be treated with or without additional colorants or other materials such as hot melt adhesives separately or simultaneously; progressively or an entire edge at a time; before, after or during cutting the module from a floor covering web; and by moving a module past one or more treating devices or by moving the treating device(s) past the module.

Relatively high speed production of modules having the grouted edge appearance of this invention may be accomplished by conveying a tile past treating stations such as hot air guns or devices for applying hot melt adhesive or colorant. Two such stations can treat opposed edges of a square or rectangle tile while the tile is conveyed in a first direction. Two more stations can then treat the remaining two edges while the tile is conveyed in a direction orthogonal to the first direction or after rotating the tile 90 degrees.

In summary, possible techniques and devices for achieving the “grouted edge treatment” of this invention include the following, which can be use separately or in various combinations:

1. Ultrasonic etchers;

2. Lasers;

3. Hot air guns;

4. Hot air knives;

5. Hot rolls;

6. Textured hot rolls;

7. Hot elements other than rolls, such as hot plates and bars;

8. Polyvinylchloride ink;

9. Flexographic ink;

10. Other inking processes;

11. Chemical application (e.g. dyes);

12. Chemical burning of the yarn;

13. Chemical alteration of the edges;

14. Topical chemical application spray, roller, flick roll, lick roll, transfer coated, film transfer, etc; and

15. Cutting away a peripheral portion of the face material.

Another feature of this invention includes changing the color, gloss and texture of the module utilizing heat guns, die coaters and embossers.

In still another feature of this invention, other treating methods, such as, for instance, impulse heating, radio frequency sealing or lasers are utilized to create a tile having a grouted appearance edge.

### BRIEF DESCRIPTION OF THE DRAWINGS

FIG. 1 is a perspective view of treated flooring modules placed together forming a floor covering.

FIG. 2 is a side elevation, schematic view of a tile treated in accordance with this invention with alternative edge shapes.

FIG. 3 is a side elevation, schematic view of edge-to-edge bonding of a flooring module of this invention.

FIG. 4 is a side elevation, schematic view of fabric-to-fabric bonding of flooring modules.

FIG. 5 is a perspective view of treated flooring modules and a heat source utilized with a “manual” embodiment of this invention.

FIG. 6 is a side elevation schematic view of a hand apparatus including a hot air gun utilized in the “manual” embodiment of imparting a treated edge to a flooring module.

FIGS. 7A and 7B are top plan views of an apparatus including conveyor belts and heat guns for producing a grouted appearance edge on modular flooring.

FIG. 8 is an enlarged perspective view of a portion of the apparatus of FIGS. 7A and 7B showing one of the heat guns.

FIG. 9 is a top plan view of another embodiment of this invention showing an apparatus for providing a module having a grouted appearance edge tile including a textured surface that can be made in a variety of colors.

FIG. 10 is a perspective view of a die coater usable to apply hot melt adhesive in the embodiment of this invention depicted in FIG. 9.

### DETAILED DESCRIPTION OF THE INVENTION

I. Introduction

This invention provides textile fiber face modular and broadloom or roll goods flooring having edges treated with a “grouted-edge” appearance and machinery and methods for making the flooring. Alternatives for accomplishing this modular flooring include both “manual” and automatic embodiments.

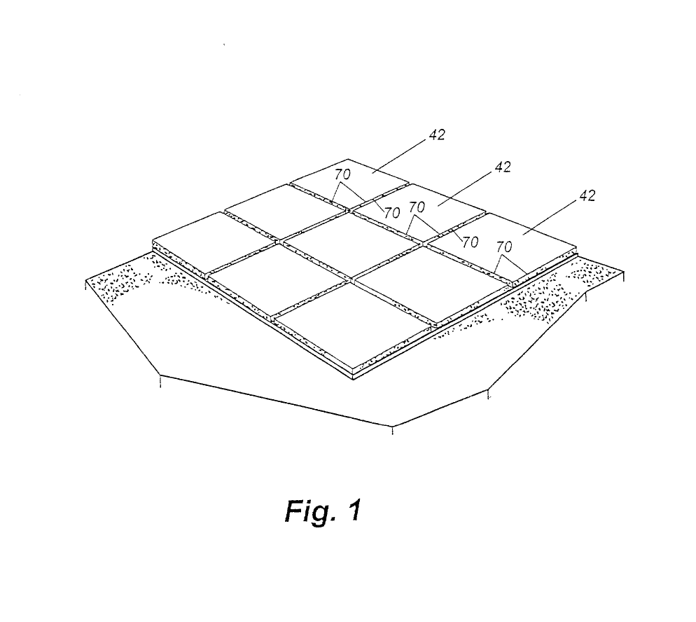

FIG. 1 illustrates a perspective view of several tiles 42 placed together. Each tile 42 has the “grouted edge treatment” 70. The treated edge 70 is represented in FIG. 1 by the shaded portion of the tiles 42. As shown in FIG. 1, the tiles 42 are aligned such that the edges create a grout-like appearance between tiles.

II. Edge Treated Floor Covering Structure and Installation

A. Structure

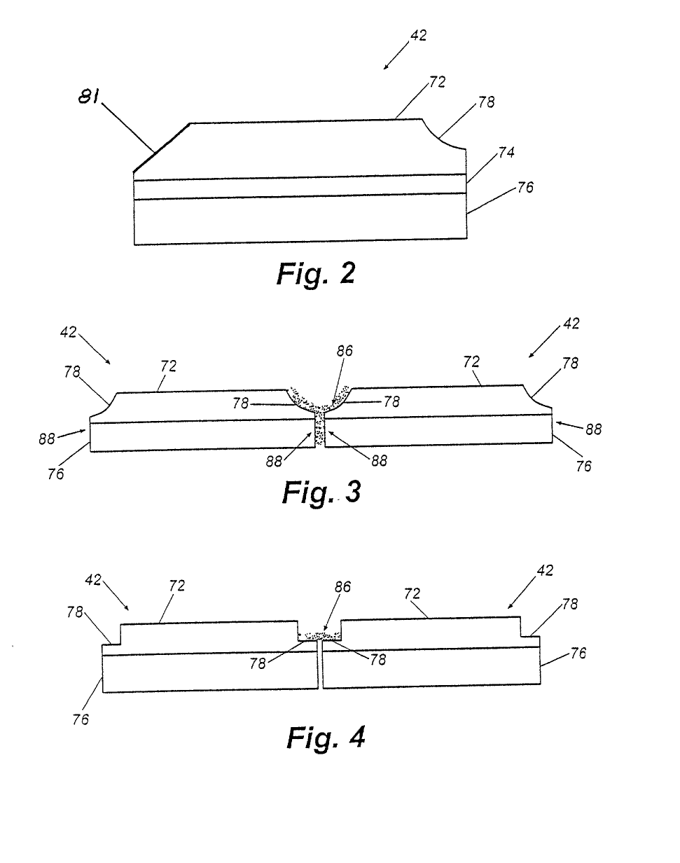

FIG. 2 shows a side elevation, schematic (not to scale) view of roll goods or modular flooring, such as tiles 42, treated in accordance with this invention. The flooring material such as a tile 42 has a top or face layer 72 of textile material, such as woven fabric, tufted fibers, looped fibers, knitted fibers, fusion bonded fibers or another structure. Face layer 72 could include a precoat. An example of a woven fabric usable for layer 72 is disclosed in International Application No. PCTIUS98/21487, entitled “Floor Covering With Woven Face,” dated October 13, 1998, which is incorporated herein by this reference. A backing layer 74 and a resilient layer 76 lie under the face material 72. The flooring material 42 has regions 78 and 81 at the two sides of the cross section that are different in appearance than the rest of the textile material 78 and may be lower than the nontreated portion of the flooring material 42.

The edge treatment of this invention using any of the methods described here can occur after the product has been cut into modules or, in the case of modules produced from a web, can occur before the web carpet is cut into modules or tiles.

If the appearance of smaller modules than the entire tile size is desired, a treatment similar to the edge treatment can also be applied across the tile, making it appear that a single module actually is a larger number of smaller modules. For instance, if a marking centered side to side in a square or rectangular tile is positioned between each pair of opposed edges, the tile will appear to be divided into four smaller tiles. Any of the “grouted edge” treatments described here could also be used to create patterns on the face of the tiles in order to give the tile surface a three dimensional appearance.

An alternative and or additional way of achieving the desired “grouted edge” treatment is to use additional “grout-like” material between adjacent edges of floor covering, such as conventional cementitious grout. Such filler materials may not necessarily be conventional grout but instead can be, for instance, hot melt adhesives, glue and a wide variety of polymeric materials including, in particular, polymers the same as, or compatible with the polymer(s) that form the floor covering. Such “grouts” can serve not only aesthetic functions but also utilitarian ones. They can bond the floor covering to underlying floor, serve as a moisture barrier, seal floor covering edges and provide enhanced strength, among other things.

Such “grout” material is illustrated in FIG. 3 as glue 86, which can be placed on the carpet in several ways. FIG. 3 shows a side elevation, schematic (not to scale) view of backing-to-backing bonding of tiles. This application is particularly appropriate for flooring having relatively thin face fabric. In this case the glue 86 is placed not only on the face of the flooring at the perimeter 78 or 81 of the tile 42, but also on the edge 88 of each tile 42. Immediately before or after the tiles 42 are placed side by side, a heat gun or other heat source is utilized to heat the glue 86 on the perimeter 78 and edge 88 of adjacent tiles so that the adhesive flows and bonds together. Thus, the two tiles 42 bond not only the upper-to-upper face fibers, but also side-to-side and backing-to-backing.

FIG. 4 shows a side elevation, schematic (not to scale) view of fabric-to-fabric bonding of tiles 42. For an application that involves pile carpet, among other situations, it may be more appropriate to apply glue 86 only to the upper fibers of the perimeter 78 or 81 of the tile 42. When the top side perimeter of each tile 42 is heated, the glue 86 melts and bonds pile-to-pile or fabric-to-fabric of adjacent tiles.

B. Installation

When the tiles 42 are installed in the field, the edge region of the tiles 42 may be reheated to melt or fuse abutting edges together by fusing the hot melt adhesive, which: (1) creates a bond between the tiles, thereby provides a moisture impermeable floor covering and (2) hides the seam between tiles and enhances the grout-like appearance.

Both backing-to-backing and fabric-to-fabric bonding allows the glue gun or hot melt adhesive application to provide a tile with the grout-like edge appearance having the tile-to-tile bonded capabilities and moisture barrier.

III. Techniques for Producing Grouted-Edge Appearance

The floor covering of this invention can be produced utilizing a wide variety of techniques.

A. Hot Air

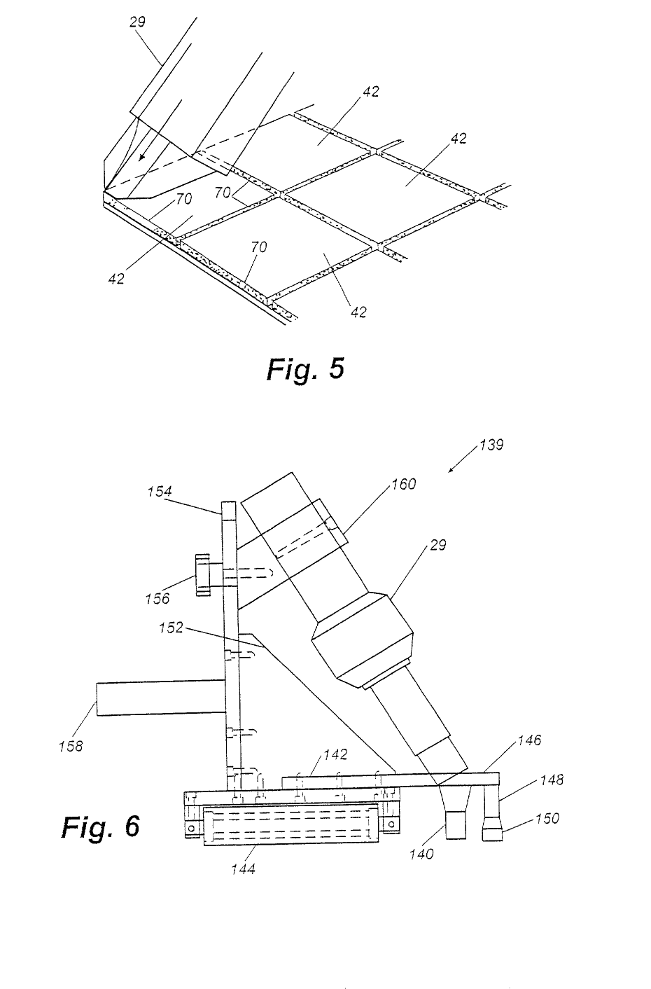

The floor covering of this invention can be produced utilizing hot air that is directed against a peripheral portion of the floor covering 42 to melt, consolidate and discolor a portion of the face as illustrated in FIG. 5. Methods and apparatus for such treatment is described in detail in sections B-F below.

B. Hot Melt Adhesive Treatment

A glue gun can extrude a “ribbon” of hot melt adhesive through a small slot positioned adjacent to the tile 42 portion being treated to provide a grout-like appearance on the tile 42. Such a glue gun is available as a model HA2 one module slot coater applicator used in conjunction with a STS 50-4H hot melt supply unit from Suretack Systems, a division of Crist Company, 201F Bell Place, Woodstock, Ga. 30188. The glue gun includes an extruder for releasing stored glue and a heat source for heating the glue. The glue gun applies glue to the four edges of a tile 42. The glue can be applied to the periphery of the square tiles from a few hundredths of an inch up to an eighth of an inch or more, providing a grout-like region of twice that width when two tiles are placed adjacent to each other. Preheating at least the portion of the tiles 42 on which hot melt adhesive is applied may be desirable to slow cooling of adhesive and facilitate deeper penetration of the face fibers 78 of tile 42. This provides for maximum penetration and consolidation of the fibers. An appropriate hot melt coating based on EVA (ethyl vinyl acetate) is product 52-428 supplied by The Reynolds Company, 10 Gates Street, P.O. Box 1925, Greenville, S.C. 29602. Hot melts and comparable alternatives can include the following ingredients: ethylene vinyl acetate polymer; styrene butadiene polymer; polyolefin polymers; styrene isoprene polymer; petroleum derived tackifying resins; rosin derived tackifying resins; paraffin waxes and oils; terpene derived tackifying resins; microcrystalline waxes and oils; napthanic waxes and oils and polyamide resins.

C. Impulse Heating

Impulse heating may also be utilized to create a grouted appearance edge on a flooring module. The impulse heating apparatus includes a brass bar that is heated by resistance heating. The bar surface adjacent to the flooring module may be covered by Teflon® tape. Vertrod Corporation, Brooklyn, N.Y. provides impulse heating machinery suitable for use with this invention. In operation, the brass bar optimally covered with Teflon® tape contacts the module then high voltage electricity heats the module edge and the bar releases. The cycle time required to treat a module is a function of the pigments, depth and type of carpet tile module being treated.

Impulse heating may also be used on a flooring web in conjunction with a die cutting apparatus for cutting the web into tiles or modules. By positioning impulse heating bars adjacent to die cutting blades or knives, a web of flooring material may be cut and the module heat treated in one step.

D. Radio Frequency Sealing

Radio frequency sealing may also be utilized to treat the edges of the module. A thermoplastic tape or film is applied to the edge of the module and radio frequency energy passes from a transmitter through the module to a receiver, heating the module and tape. Radio frequency sealers available from Kabar Manufacturing Corp., Farmingdale, N.Y. and tape material such as Thermx™ polyester made by Eastman Chemical Company, Kingsport, TN are suitable products for use with this invention.

Tapes in a variety of colors can be utilized with both impulse heating and radio frequency sealing to provide a decorative module edge finish. Suitable tapes include unsupported films and supported films. Unsupported films (i.e. adhesives) can include a chemical composite such as, for example, olefinic polymers, unsaturated polyester or polyamides (i.e. nylon). Bemis Associates Inc., Shirley, Mass. provides suitable unsupported films. Supported film has an adhesive and a supporting layer. The supporting layer can include another fabric or film (or mylar) that is not thermoplastic. Fabrics that are woven or nonwoven such as, polyesters, nylons, polypropylene and knits are suitable for use as the supporting layer.

E. Flocking

Flocking can also be utilized to provide a treated edge. Flocking includes a supported film and an upper layer adapted to impart color. In addition, flocking materials can be affixed to the edge of the module and embossed to provide a textured, decorative appearance to the module. Fabrex International Limited, Lancaster Road, Hinkley, Leicestershire, United Kingdom provides suitable flocking material.

F. Lasers

In another embodiment, a laser is utilized to provide the grout-like edge appearance on flooring modules. Lasers can also be used to “engrave” more complex patterns on the tile, such as a broken “quarry tile” appearance, and to engrave “grout lines” in a middle portion of the tile making one tile look like many. A thermoplastic coating such as, for instance, tape or film, can be applied to the module before the laser treatment. Such a “grouted-edge” appearance can be accomplished using the techniques (described for other purposes) set forth in U.S. Pat. No. 4,629,858, entitled “Method For Engraving Carpet And Carpet So Engraved,” which is incorporated in its entirety herein by reference.

G. Cutting or Shearing

The desired change in the appearance of tile 42 may be achieved by cutting away a portion of the face 72 of tile 42 to leave a region 78 or 81 that can have a convex surface, a concave surface 72, a flat, beveled surface 81 or any other desired shape. Among other devices usable to cut away face material is a shear often referred to as a “tile edger” available, for instance, as an “automatic belt-type 90° tile edging machine” sold by B&J Machinery Company, 122 York Street, Dalton, Ga. USA. Such a “tile edger” shear is normally used to remove fuzz or stray fibers from the edge of a carpet tile. In use in practicing this invention, however, the shear is positioned to cut a portion of the pile of a tufted carpet module or other textile face flooring module to leave a bevel 81 as illustrated in FIG. 2 or another surface with a different shape that is visually apparent. For instance, among other shapes possible is the rabbit shape illustrated in FIG. 4.

IV. Machinery for Treating Floor Covering

A. “Manual” Treating Machine

In a “manual” embodiment of this invention shown in FIG. 6, an apparatus 139 for mounting a hot air gun 29, such as, for example, a Leister Hot Air Welder model number 1G3, available from Heely Brown Company, Inc., Atlanta, Ga. An suitable apparatus is disclosed in provisional patent application entitled “Hand Apparatus for Imparting Grouted Edge Appearance to Tile Face Floorcoverings,” filed January 20, 2000 and is incorporated herein by this reference.

A textile fiber face modular tile or floorcovering 42 is treated with the hot air gun 29 that is moved along the edge 70 of a stationary tile 42. The orientation of a tip 140 of the hot air gun 29 provides for directing air to a peripheral portion of the floorcovering 42. A base plate 142 rests on rollers 144 that contact the floorcovering 42. Arms 146 are adjustably mounted to project from base plate 142. Each arm 146 terminates in a leg 148 projecting down, which in turn terminates in a guide roller 150 that bears against the edge of floorcovering 42 being treated. The guide roller 150 working in cooperation with the rollers 144 provide control and stability so that an operator can efficiently impart hot air to the floorcovering 42.

The hot air gun 29 is adjustably mounted on base plate 142 utilizing a sloping gusset or carriage 152 bolted to stanchion 154 with adjustable fasteners 156 permitting adjustment in the height of hot air gun 29 above floorcovering 42. A handle 158 affixed to stanchion 154 can be useful in operating this apparatus. A heater bracket 160 adjustably attaches the hot air gun 29 to the stanchion 154.

The air from the hot air gun is delivered through small holes in the appropriately shaped tip 140 to a peripheral portion of the tile 42 such as a region, for instance, approximately ⅛ to ¼ inch wide (although wider areas may be desirable in some instances) and then pinch rollers may optionally be used to compress the heated fiber. The tip 140 of the air gun 29 and the pinch rollers move along the edge of the module. In another embodiment, a heated contact implement similar, for instance, to the tip of a soldering iron can be briefly brought in contact with a peripheral portion 70 of the tile 42 to treat that portion. Alternatively, the edge treatment 70 could be accomplished using infrared radiation or laser light, or by contacting portions of the tile 42 to be treated with a heated die having the pattern desired to be “imprinted” on the tile.

In another embodiment, a peripheral portion 70 of the tile 42 is treated with an ultrasonic machine, such as an ultrasonic “etching,” “welding,” or “bonding” machine. With ultrasonics, the tile fiber is generally compressed rather than melted and broken as with a heat treatment. Compressing the face yarn prevents edge ravel, because the face yarn of the treated region is compressed together. The compressed face yarn is also depressed below the nontreated yarn creating a “grout-like” appearance 70 when placed together with similarly treated tiles 42. Additionally, ink can be used with the ultrasonic machine to change the color of the treated region. Ultrasonic machines currently used to create designs in textile products such as mattress covers and quilts can be adapted for this application.

B. “Automatic” Tile Edge Treatment Machine Using Hot Air Only

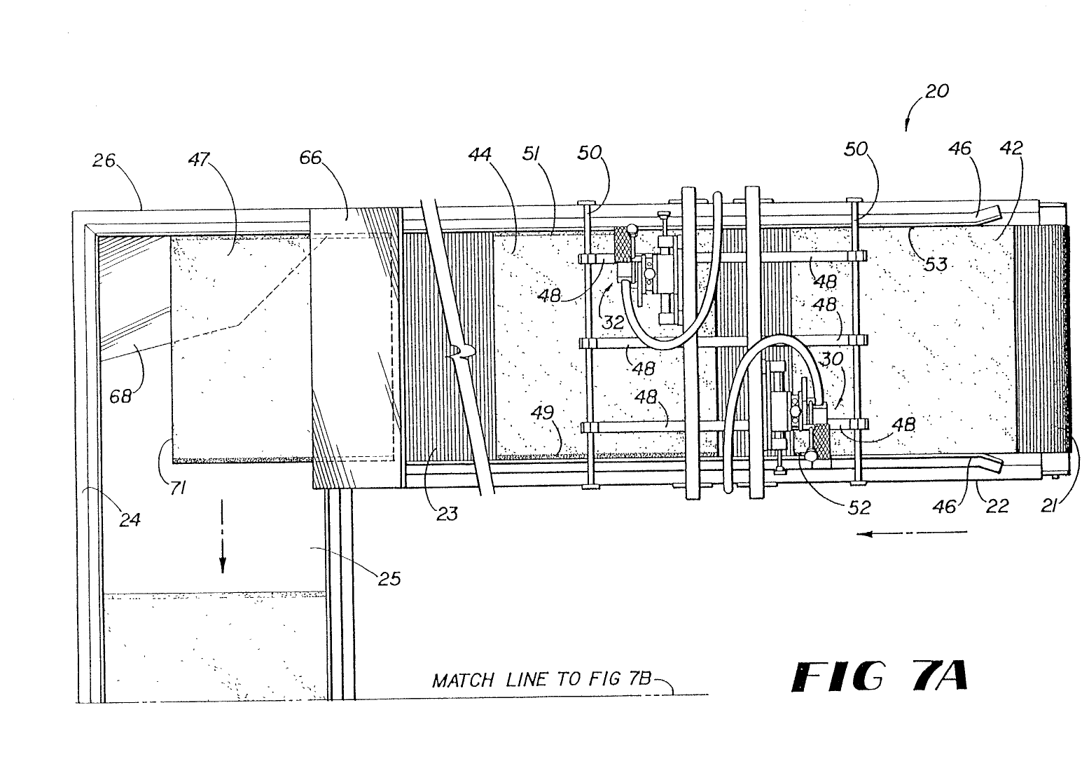

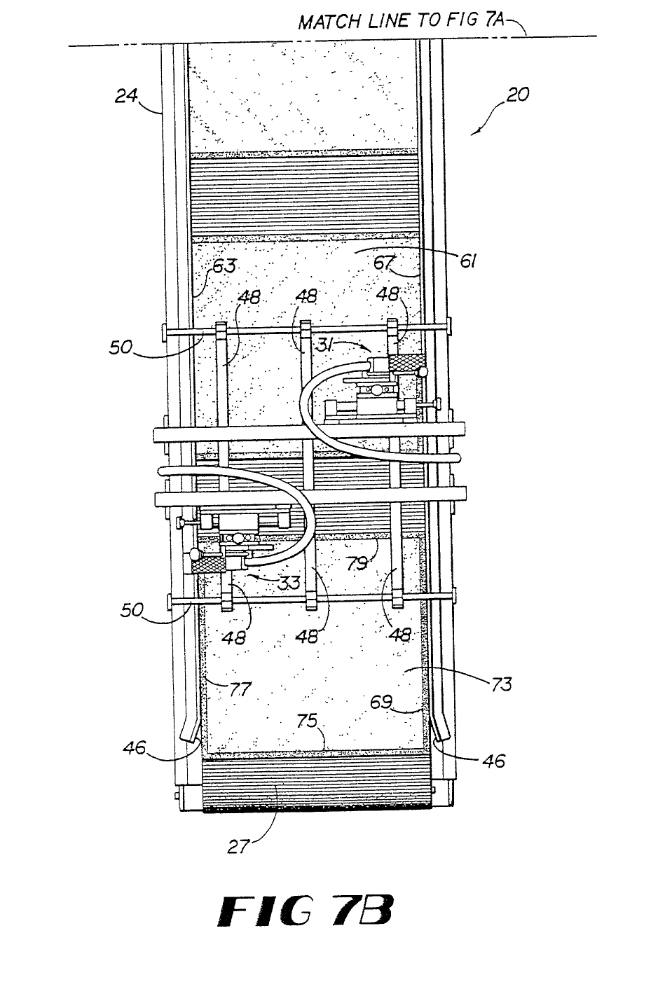

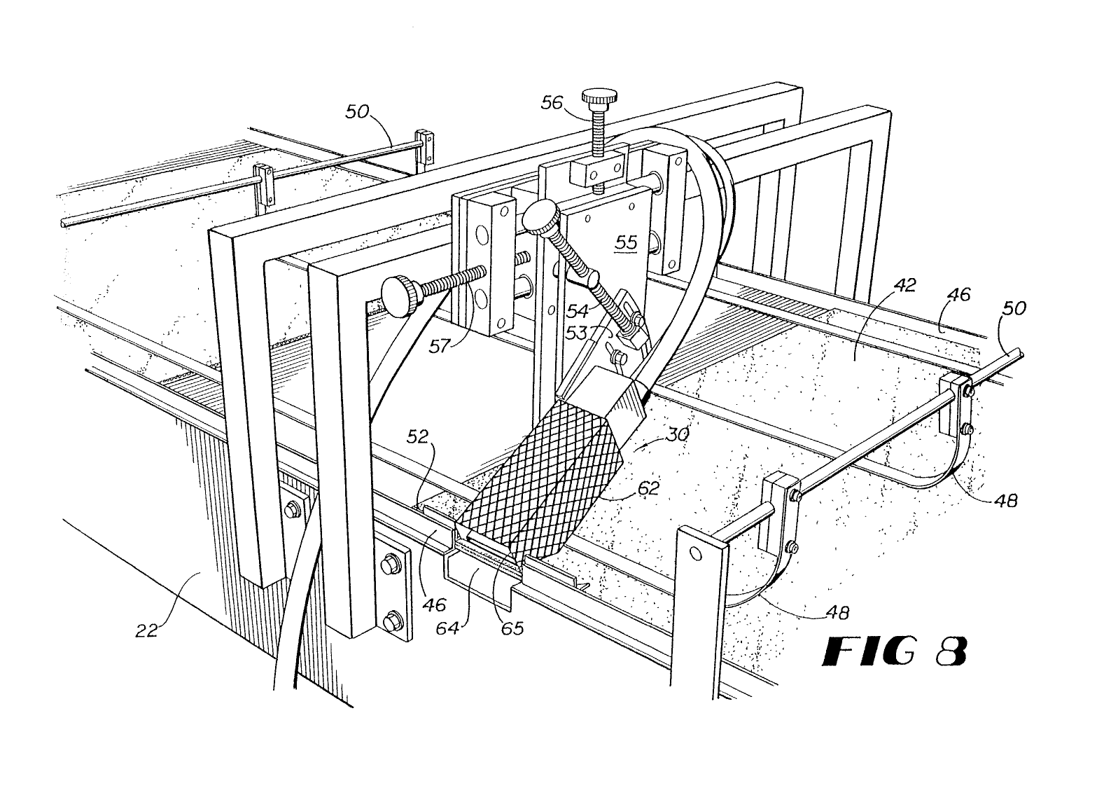

FIGS. 7A and 7B show a top plan view of a production apparatus or machine 20 for imparting a grouted-edge appearance to square or rectangular modular flooring, such as a carpet tile or other modules having a textile fiber face. As shown in FIG. 7A, the machine 20 includes a conveyor line 22, and treating heads 30, 32 that can be heat sources. A second conveyor line 24 is positioned to be fed by conveyor line 24 at right angles to conveyor line 22.

The conveyor line 22 is positioned to traverse in a substantially horizontal direction to move modules 42, 44 and 47 past the heat sources 30, 32 to treat two opposed edges. A second pair of heat sources 31 and 33 treat the other pair of opposed module edges on the next conveyer line 24. Each conveyor line 22, 24 rests on legs (not shown) which support it at a convenient height for a worker placing modules on and removing modules from the machine 20. A control box (not shown) has controls for stopping the machine 20 and for controlling each conveyor line 22, 24 and heat sources 30, 31, 32 and 33. In one embodiment, the heat sources 30, 32 are a heat gun such as a Leister TWINNY Y heat gun or Leister Hot Air Welder model number 1G3. In another embodiment, the heat sources 30, 32 are a laser.

FIG. 7A shows a top view of flooring tiles 42, 44 on the first conveyor line 22. Tiles are placed on the first conveyor line 22 such that they are adjacent to (or abut) each other. The conveyor lines 22, 24 include fences 46 on each side. The fences 46 serve to position the tiles 42, 44 so that the edges will be properly treated. Spring strips 48 attached to parallel bars 50 affixed over the conveyor lines 22 and 24 serve to eliminate lifting, curling or puckering of the tiles 42, 44 while traveling along the conveyor lines 22 and 24.

As shown in FIG. 7A, two adjacent tiles 42, 44 are being treated by heat guns, 30 and 32, respectively. One edge 49 of the tile 44 was first treated first by heat gun 30. As the tile 44 progresses along the conveyor line 22, the opposite edge 51 is heat treated by the other heat gun 32. The adjacent tile 42 is in position to be treated from the heat gun 30. Heat is first applied to one edge 52 of the tile 42. As tile 42 passes underneath heat gun 32, the opposite edge 53 of tile 42 will be treated. Spring strips 48 apply slight pressure on the tiles 42, 44 so they remain in position on the conveyor line 22. Tiles 42, 44 and 47 are transported along the first conveyor line 22 to a chute 66 that transitions the tile 47 to the second conveyor line 24.

The downstream end 26 of conveyor line 22 is elevated so that a tile 47 can drop from conveyor line 22 onto conveyor line 24. The chute 66 receives the tile 47 from the first conveyor line 22 and drops the tile 47 onto the slide 68 for positioning on the second conveyor line 24. As the tile transfers from one conveyor line 22 to conveyor line 24, the conveyor line 24 is orthogonal (i.e., at 90°) to the first conveyor line 22 so that a second edge 71 of the tile 47 can be heat treated. Thus, the tile 47 does not turn, but the second pair of edges is presented for treatment by moving tiles in an orthogonal direction as compared to their first direction of travel. Conveyor line 22 utilizes two belts 21 and 23 positioned end-to-end. Conveyor lines 22 and 24 can be: (1) one or more belts each or (2) roller conveyors or (3) other types of conveyors. Belt 21 conveys tiles 42, 44 past treating stations 30 and 32 and onto belt 23, which operates at a higher speed than belt 21, thereby separating tiles 42, 44 that were abutting when traveling on belt 21. This separation between tiles at the point where they change direction even though they abut (or are adjacent to) each other when passing the treating stations provides time for the tile 47 to drop, and settle in position on the next conveyor belt 25 and start moving orthogonal to the original direction of travel without dropping a succeeding tile on top of tile 47. Due to the change in speed, the tile 47 drops onto belt 25 of conveyor line 24, settles onto conveyor belt 25 and begins traveling in the direction of the next heat source 31 shown in FIG. 7B before the next tile 44 drops onto belt 25. Belt 25 of conveyor line 24 may also be operated at a higher speed to feed belt 27 running at a lower speed.

Alternatively, an apparatus for rotating each module 90° could be used between conveyor lines 22 and 24 so that both conveyor lines 22, 24 could move modules in the same direction.

A tile 61 having two treated edges 62 and 64 travels along the conveyor line 24 to have the remaining two edges 63, 67 heat treated. Edge 67 is treated by heat gun 31. As the tile 61 continues to traverse along the conveyor line 24, the edge 63 will be treated by the heat gun 33. The result is a tile 73 discharged from belt 27 having all four edges 69, 75, 77 and 79 heat treated.

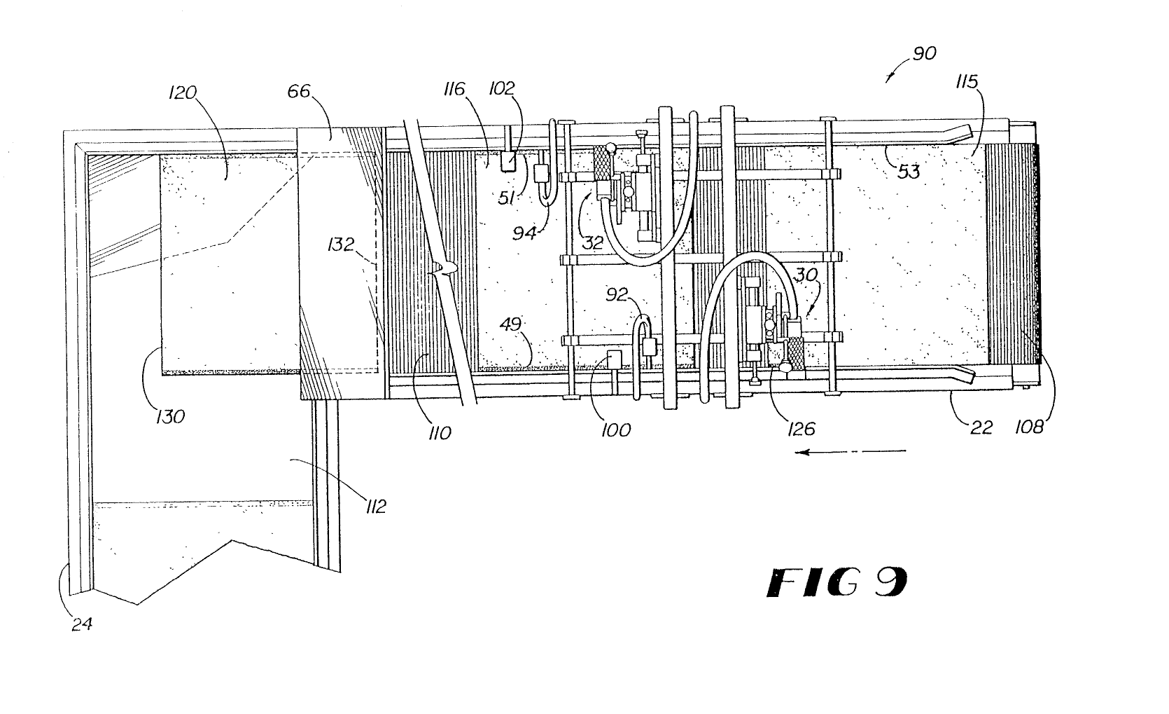

FIG. 8 shows a close up view of the energy source or heat gun 30, and illustrates a tile 42 being treated by the heat gun 30. A gap 64 in the conveyor line 22 positioned beneath a nozzle 65 of the heat gun 30 vents the hot air from heat gun 30. The heat gun 30 includes a narrow slot that allows for focusing the heated air on the tile 42. The tile 42 travels along the conveyor line 22 with an edge 52 of the tile 42 adjacent to the fence 46. The heat gun 30 delivers focused hot air and radiant energy to the edge 52 of the tile 42 to produce a grout line appearance in an area of a desired width, typically between a few hundredths of an inch to about one half of an inch wide. The nozzle 65 of the heat gun 30 blows air against an edge 52 of the tile 42, causing an indentation 78 in the tile 42, thereby creating a “grouted” edge appearance. Thus if two tiles 42, 44 having grouted edges of one eighth an inch in width are positioned side-by-side, the total grout line appearance is about one quarter an inch.

The position and inclination of the heat gun 30 is adjustable. Each heat gun 30, 31, 32, and 33 mounts on a pivoting plate 53 that, in turn mounts on a carriage 55 that is adjustable in height and lateral position. The pivoting plate 53 is controlled by a threaded rod 54 that can adjust the pivotal position of the plate 53 on the carriage 55 and, therefore, the inclination of the heat gun 31. The carriage 55 can travel vertically on rods 54, 56, and its vertical position is adjustable with rod 56. The carriage 55 travels horizontally on rods 54, 56, and its horizontal position is adjustable with rod 57. A cage 62 can be placed around the heat gun 31 to prevent inadvertent contact with hot surfaces.

C. “Automatic” Machine With Die Coaters and Contact Treating Heads.

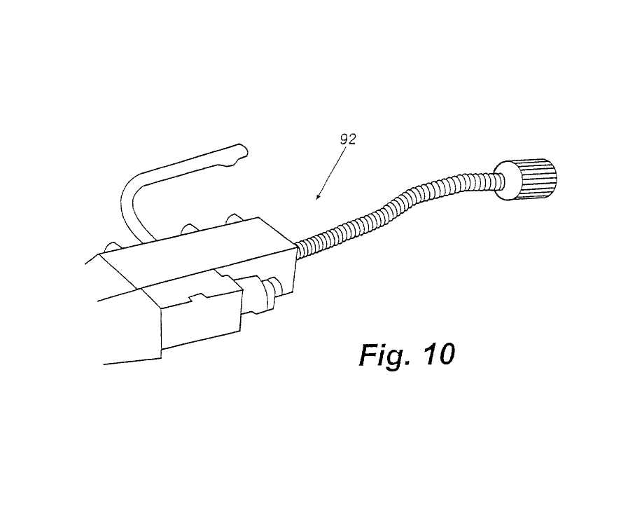

FIG. 9 is a top plan view of another embodiment of this invention showing an apparatus 90 similar to apparatus 20 for providing a module having a grouted appearance edge tile including a textured surface that can be made in a variety of colors. The apparatus 90 includes treating heads that may be heat sources 30, 31, die coaters 92, 94, and contact treating heads 100, 102 (that may be embossers, shears or other devices). Conveyor lines 108, 110 and 112 traverse substantially horizontally moving modules 115, 116 past the heat sources 30, 31, die coaters 92, 94, and contact treating heads 100, 102. The module 116 edge 126 first receives heat treatment from the heat source 30, such as for instance, a heat gun. The die coater 92 is positioned adjacent to the heat gun 30 and provides a coating application to the melted edge 126 of the module 115. FIG. 10 shows an illustration of a die coater 92. A suitable die coater is available from Suretack Systems of Woodstock, Ga.

Referring to FIG. 9, a thermoplastic coating is applied to the pre-heated end 126 of the module 115. Suitable thermoplastic coatings include, but are not limited to, polyolefins, polyurethanes, polyesters and polyamides. By adding a thermoplastic coating to the module 115, a variety of levels of gloss from shiny to dull and colors can be added to the module 115. After the thermoplastic coating has been applied, embossing can occur utilizing an embosser as contact treating head 100. Embossing involves stamping or impressing a pattern into the module 115. An embosser may use a wheel on an arm that positions the wheel to contact tile 115. The wheel rolls over the module 115 creating an engraved pattern appearance while the module 115 is warm and soft.

For example, embossing can create a concrete-like textured appearance or a module edge that resembles a bound edge. At the end of conveyor line 110, the module 120 does not turn, but a second pair of edges 130, 132 are presented for treatment by moving tiles in an orthogonal direction as compared to their first direction of travel (past a second set of heat guns 30, 32, die coaters 92, 94, and contact treating heads 100, 102 not shown). The result is a module 115 having all edges treated. The combination of heat guns 30, 31, die coaters 92, 94, and contact treating heads 100, 102, allow the completed module to have many variations in color, gloss and texture.

Alternatively, a module 115 can be treated only by the heat guns 30, 31, and die coaters 92, 94, or a module 115 can be treated by only the heat guns 30, 31, and contact treating heads 100, 102. Any combination of heat guns 30, 31, die coaters 92, 94, and contact treating heads 100, 102, can be used on a module 115.

Additionally, other techniques and devices can be added to the apparatus shown in FIGS. 7A, 7B, 8 and 9 or substituted for the heat sources 30, 32. For instance, hot melt glue application devices could be added or substituted. Likewise apparatus for cutting or shearing a portion of the module face, such as the shear described above could be attached to machine 90 in the position of contact treating heads 100 or 102. If one or more shears are used, they typically will be positioned to treat a particular peripheral region of a module 115 before any other type of treating heat and sometimes to the exclusion of use of any other type of treating head.

In another embodiment, the tile remains stationary on the apparatus and the energy sources move around the tile, treating the perimeter or other portions of the tile creating the grout-like appearance edge.

While certain embodiments of this invention have been described above, these descriptions are given for purposes of illustration and explanation. Variations, changes, modifications and departures from the systems and methods disclosed above may be adopted without departure from the spirit and scope of this invention.

1. A method for imparting a grouted edge appearance to a flooring module having a textile face, the method comprising:
moving the module and a shear relative to each other to remove a peripheral portion of he textile face.

2. A method for imparting a grouted edge appearance to a flooring module comprising:
conveying the module in a first direction past at least one shear to remove a peripheral portion of the module;
conveying the module in a direction orthogonal to the first direction, or in the same direction after rotating the module, past at least one other treating head.

3. A flooring module usable with other like modules to provide a floor covering, the module comprising:
an upper wear surface having a visible textile fiber face, of which a peripheral portion of the face has been removed to create a different appearance from the other portion of the face; and
a lower backing surface affixed to the upper wear surface.

4. The flooring module of claim 3, wherein the upper wear surface comprises a pile carpet structure.

5. The flooring module of claim 3, wherein the upper wear surface comprises woven textile fibers.

6. The flooring module of claim 3, wherein the removed portion leaves a beveled surface.

7. An apparatus for creating a grouted edge appearance on an edge of a flooring module having a textile fiber face, comprising:
a shear; and
a conveyor for moving one of the module or the treating unit relative to the other of the treating unit or the module.

8. The apparatus of claim 7, further comprising moving the module relative to the treating unit.

9. The apparatus of claim 7, wherein the shear is a tile edger.

10. The apparatus of claim 7, further comprising moving the treating unit relative to the module.

11. An apparatus for creating a flooring module of textile fiber face having edges different in appearance from the remainder of the face comprising:
two shears for treating the a set of opposed edges of the module; and
a conveyor for moving the module past the shears.

12. The apparatus of claim 11, wherein the conveyor moves each the module edges past at least one of the shears.

13. Floor covering, comprising a plurality of modules of textile fiber face material having edges and having portions for the face near the edges different in appearance from the remainder of the face as a result of removal of face material, the modules positioned with abutting edges. at gun.
